(19) United States
(12) Patent Application Publication
(10) Pub. No.: US 2026/0010377 A1
(43) Pub. Date: Jan. 8, 2026

(54) INFORMATION PROCESSING APPARATUS

(71) Applicant: HITACHI ASTEMO, LTD., Hitachinaka-shi, Ibaraki (JP)

(72) Inventors: Kota IDEGUCHI, Chiyoda-ku, Tokyo (JP); Katsuya YAMAUCHI, Chiyoda-ku, Tokyo (JP); Mikio KATAOKA, Chiyoda-ku, Tokyo (JP); Yasuhiro FUJII, Chiyoda-ku, Tokyo (JP); Nobuyoshi MORITA, Chiyoda-ku, Tokyo (JP)

(73) Assignee: HITACHI ASTEMO, LTD., Hitachinaka-shi, Ibaraki (JP)

(21) Appl. No.: 18/840,609

(22) PCT Filed: Apr. 17, 2023
(86) PCT No.: PCT/JP2023/015322

§ 371 Date: Mar. 10, 2025

(30) Foreign Application Priority Data
Jun. 14, 2022 (JP) 2022-095964

(51) Int. Cl. G06F 9/4401; H04L 9/32

(52) U.S. Cl. CPC G06F 9/4401; H04L 9/3247

(57) ABSTRACT

A computation unit that performs a computation process for a program and a storage unit that stores a first control program and a first startup program that executes signature verification for the first control program are provided. The first startup program can execute a plurality of signature verification methods, and executes a process for determining, among the plurality of signature verification methods, a signature verification method that corresponds to a signature type for the first control program and obtaining a result of executing signature verification by the signature verification method.

### TECHNICAL FIELD

The present invention pertains to an information processing apparatus, and particularly pertains to an information processing apparatus that performs signature verification for a control program at a time of a secure boot.

### BACKGROUND ART

For an embedded system mounted in an automobile, a home appliance, a medical device, or the like, there is concern that a case where software or firmware is rewritten by an attacker in an unauthorized manner will lead to immense damage. As a countermeasure for such a threat, there has been considered a secure boot technique that enables only a program that has not been altered to be started up when starting up an ECU.

As one method for a secure boot, Patent Document 1 discloses a technique by which, when a client apparatus is started up, the correctness of a program to be executed is verified on the basis of information obtained from a server apparatus and the program is subsequently executed.

### PRIOR ART DOCUMENT

### Patent Document

Patent Document 1: JP-2011-003020-A

### SUMMARY OF THE INVENTION

### Problems to be Solved by the Invention

Normally, a cryptographic algorithm that is for program verification and is used at a time of a secure boot is fixed for each ECU. Accordingly, in the future when the cryptographic algorithm is compromised by advanced cryptanalysis due to, inter alia, technology progress of quantum computers, a secure boot itself will weaken and become a very large problem in terms of security.

According to the technique in Patent Document 1, a normal boot program and an encrypted OS use different cryptographic algorithms, and there is the suggestion that a high-speed cryptographic algorithm may be selected at this point. Therefore, it can be said that a plurality of verification methods are provided, but there is only one normal boot program for startup and, when this is compromised, as expected, there will be a large problem in terms of security.

The present invention is made in light of the above problems, and an objective of the present invention is to provide an information processing apparatus that enables a transition to a different cryptographic algorithm in a case where a cryptographic algorithm for a secure boot is compromised.

### Means for Solving the Problems

An example of an information processing apparatus according to the present invention has a computation unit that performs a computation process for a program and a storage unit that stores a first control program and a first startup program that executes signature verification for the first control program, the first startup program being able to execute a plurality of signature verification methods, and executing a process for determining, among the plurality of signature verification methods, a signature verification method that corresponds to a signature type for the first control program and obtaining a result of executing signature verification by the signature verification method.

### Advantage of the Invention

By virtue of the present invention, a transition to a different cryptographic algorithm is easily made in a case where a cryptographic algorithm for a secure boot is compromised, whereby it becomes possible to ensure safety in terms of security.

Further features related to the present invention will become clear from the description of the present specification and the attached drawings. In addition, problems, configurations, and effects other than those described above will become apparent from the description of embodiments below.

### BRIEF DESCRIPTION OF THE DRAWINGS

FIG. 1 is a view that illustrates a hardware configuration of an information processing apparatus according to one embodiment of the present invention.

FIG. 2 depicts block views that illustrate a functional configuration of a ROM that stores a boot loader program and a control program.

FIG. 3 illustrates a processing flow for a boot loader program according to an embodiment at a time of a single-bank configuration.

FIG. 4 illustrates a processing flow for a program update according to an embodiment at the time of the single-bank configuration.

FIG. 5 illustrates a processing flow for a boot loader program according to a first embodiment at a time of a double-bank configuration.

FIG. 6 illustrates a processing flow for a program update according to the first embodiment at the time of the double-bank configuration.

FIG. 7 illustrates a processing flow for a boot loader program according to a second embodiment at the time of the double-bank configuration.

FIG. 8 illustrates a processing flow for a program update according to the second embodiment at the time of the double-bank configuration.

FIG. 9 illustrates a processing flow for a boot loader program according to a third embodiment at the time of the double-bank configuration.

FIG. 10 illustrates a processing flow for a program update according to the third embodiment at the time of the double-bank configuration.

FIG. 11 illustrates a processing flow for a boot loader program according to a fourth embodiment at the time of the double-bank configuration.

### MODES FOR CARRYING OUT THE INVENTION

With use of the embodiments and with reference to the drawings, description is given in detail below regarding embodiments of the present invention.

Firstly, description is given for a hardware configuration of an information processing apparatus 1 according to the present invention. The information processing apparatus 1 includes the ROM (Read Only Memory) 12 that is a storage apparatus from which data can be read out, a RAM (Random Access Memory) 13 which data can be both written to and read out from, a CPU (Central Processing Unit) 11 that computes parameters necessary for vehicle control on the basis of data, and a communication module 10 that transmits a computation result after converting the computation result to a communication protocol.

In addition, the information processing apparatus 1 is mounted to a vehicle, for example, and controls the vehicle. However, the information processing apparatus 1 does not need to be mounted to a vehicle, and may be an apparatus that controls a target other than a vehicle.

The information processing apparatus 1 is connected to an update program management server 3 and a program verification execution module 4 via a communication channel 2. The communication channel 2 may physically include a plurality of communication buses, and standards for the communication buses may be all the same or all different. Standards for these communication buses include CAN (registered trademark), LIN (registered trademark), FlexRay (registered trademark), Ethernet (registered trademark), or the like.

The update program management server 3 transmits an update program to the information processing apparatus 1 in response to a request from the information processing apparatus 1 or in a case where the necessity of updating a control program has arisen. The program verification execution module 4 verifies the signature of the control program in response to a request from a boot loader program inside the information processing apparatus 1, and transmits the corresponding result to the information processing apparatus 1. The program verification execution module is, for example, configured by an HSM (hardware cryptographic module), which is a device that has obtained a certification such as an international standard and defines characteristics that cryptographic processing and a key management device should be provided with.

The information processing apparatus 1 receives data that has passed through the communication channel 2. The received data is then deployed to the RAM 13 in response to the reception thereof. Then, the CPU 11 performs a computation on the basis of data that has been written to the RAM 13 and data read out from the ROM 12. In addition, A program is embedded in the information processing apparatus 1 in advance, and the CPU 11 executes this program to thereby become able to execute processing described in the following embodiments.

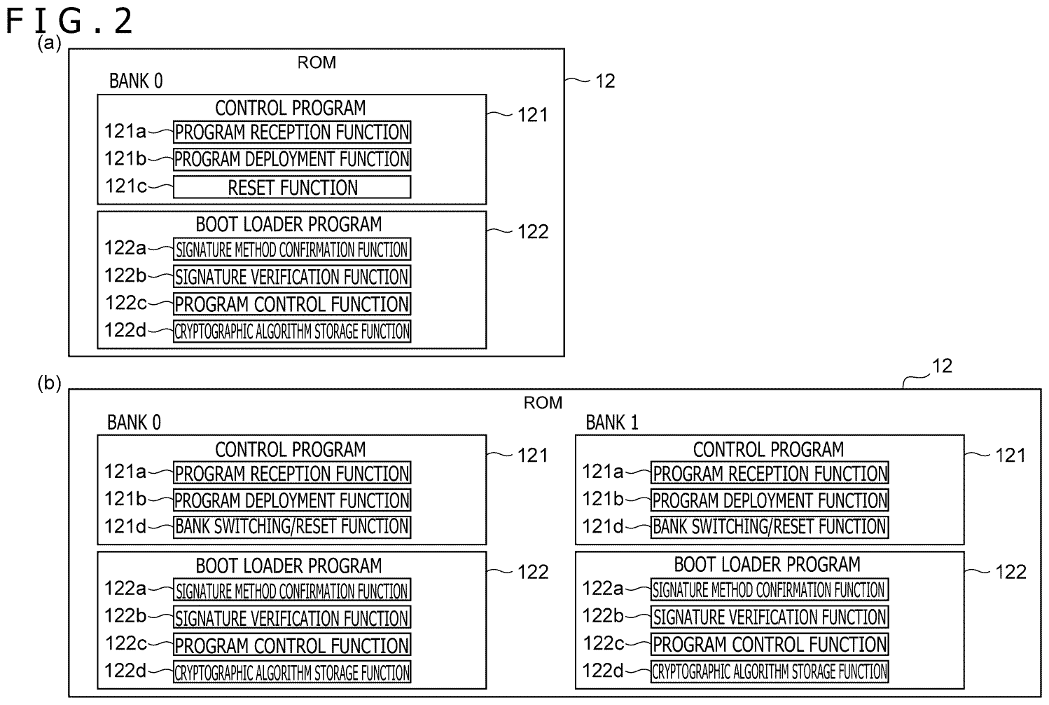

FIG. 2 depicts functional block diagrams that illustrate a functional configuration of a program stored in the ROM 12 according to an embodiment of the present invention. FIG. 2(a) is of a single-bank configuration in which there is one program storage region, and FIG. 2(b) is of a double-bank configuration in which there are two program storage regions.

As illustrated in FIG. 2(a), the ROM 12 that has the single-bank configuration has a control program 121 and a boot loader program 122. The control program 121 is a program for exercising functionality that the information processing apparatus 1 is equipped with, and is an OS (Operation System), for example, but there is no limitation to this. The boot loader program 122 is a program for verifying the signature of the control program 121 when the information processing apparatus 1 is started up and executing a secure boot process that determines whether the control program 121 has not been altered.

Stored in the ROM 12 that has the single-bank configuration is the control program 121, which has a program reception function 121a, a program deployment function 121b, and a reset function 121c. The program reception function 121a is used to receive an update program from the update program management server 3. The program deployment function 121b is used to deploy the received program within a bank 0. The reset function 121c is used to set the program to an executable state after the update program has been received and deployed.

The boot loader program 122 has a signature method confirmation function 122a, a signature verification function 122b, a program control function 122c, and a cryptographic algorithm storage function 122d. It is possible to use the signature method confirmation function 122a to confirm the signature method for the control program 121. It is possible to use the signature verification function 122b to verify the signature of the control program 121. The program control function 122c is used to execute and delete the control program 121. It is possible to use the cryptographic algorithm storage function 122d to store a plurality of cryptographic algorithms.

Note that a cryptographic algorithm may be any method including a symmetric-key cryptographic method such as AES or triple DES, or a public-key cryptographic formula such as RSA or elliptic curve cryptography. In addition, description is given by taking signature verification as an example in the present specification, but the present invention can also be suitably applied to MAC (Message Authentication Code) verification.

FIG. 2(b) illustrates a program structure for the ROM 12 that has the double-bank configuration. The ROM 12 having the double-bank configuration differs from the ROM 12 having the single-bank configuration in that the ROM 12 having the double-bank configuration has two regions, which correspond to a bank 0 and a bank 1, for storing programs and has a bank switching/reset function 121d. The bank switching/reset function 121d is used to switch between the control programs 121 stored in the bank 0 or bank 1 to be executed. Details of the difference in processing or effect between the single-bank configuration and the double-bank configuration are described below.

### <Embodiment for Time of Single-Bank Configuration>

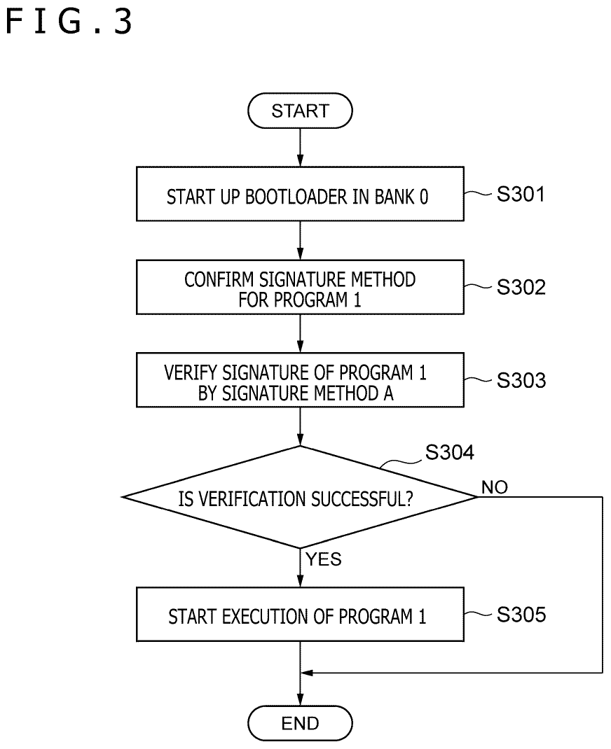

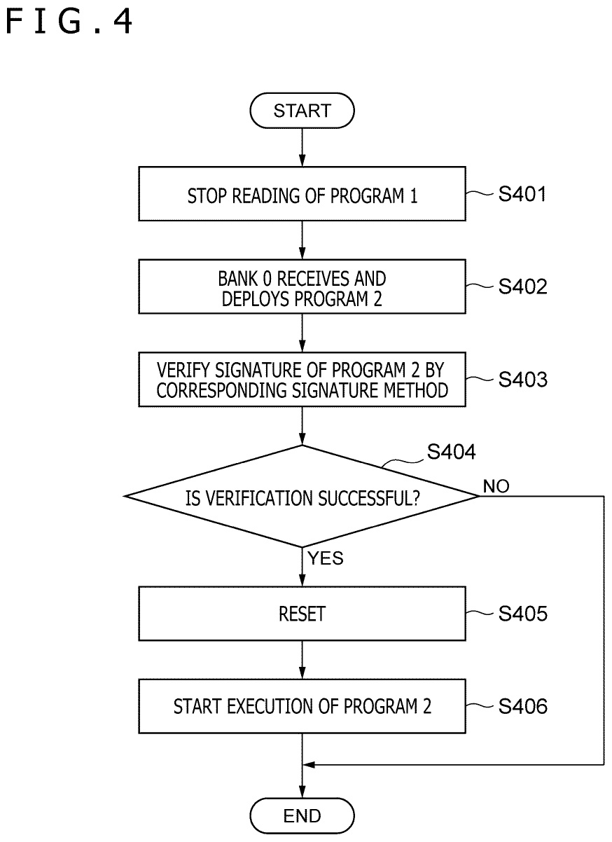

FIG. 3 and FIG. 4 are flow charts for describing processing performed in a case where the ROM 12 having the single-bank configuration illustrated in FIG. 2(a) is employed. Note that, also including at a time of the double-bank configuration, the following description is premised on a program 1 having a signature method A is stored as a control program in the bank 0 when processing is started.

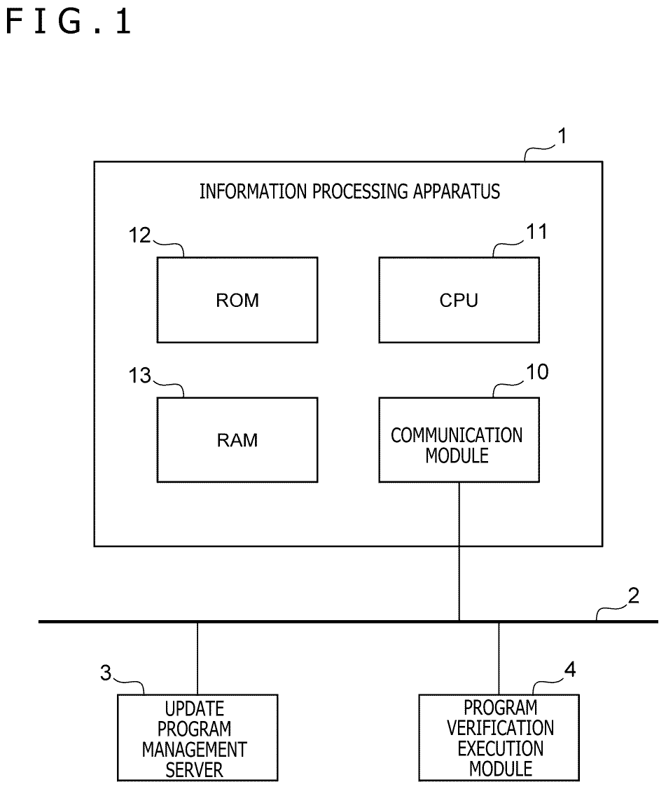

Firstly, description is given regarding FIG. 3, which illustrates a secure boot process that is executed when the information processing apparatus 1 is started up. In step S301, the boot loader program 122 in the bank 0 starts up in accordance with a command from the CPU 11. Then, in step S302, the signature method confirmation function 122a is used to confirm the signature method for the program 1. It is possible to employ a known technique for a method of confirming this signature method, and thus, description thereof is omitted. Further, in step S303, the signature verification function 122b is used to apply the signature method A to the program 1 and thereby perform signature verification. Note that this signature verification process may be a method that is executed by the program verification execution module 4 illustrated in FIG. 1 and in which the result thereof is received or may be a method that is executed by the boot loader program 122 itself.

Further, in step S304, the signature verification function 122b is used to determined whether the signature verification is successful. In a case where the signature verification fails, the processing ends as it is possible that the program 1 has been altered. In a case where signature verification is successful, in step S305, the program control function 122c is used to start execution of the program 1.

In the present embodiment as described above, the cryptographic algorithm storage function 122d is imparted to the boot loader program 122, whereby it becomes possible to prepare a plurality of cryptographic algorithms that are required at a time of a secure boot. Accordingly, in a case where a certain cryptographic algorithm is compromised, it becomes possible to easily transition to a different cryptographic algorithm without replacing the device itself.

FIG. 4 is a flow chart that illustrates an update process for a case where a necessity to update the program 1 has arisen. A case where a necessity to update a program has arisen is, for example, a case of adding a function to the program, a case of applying a patch for correcting a bug, a case where a vulnerability has been found in the program, and the like.

Firstly, in step S401, the program control function 122c in the boot loader program 122 is used to stop reading of the program 1, and the bank 0 is set to a rewritable state. Then, in step S402, the program reception function 121a is used to receive an update program 2 from the update program management server 3, and the update program 2 is deployed onto the bank 0 by the program deployment function 121b. Note that, in addition to the signature method A, it is possible to employ another signature method that is stored by the cryptographic algorithm storage function 122d, as the signature method for the program 2. In addition, program reception can be performed by an OTA (Over The Air) method, for example.

In step S403, the boot loader program 122 is started up again, and signature verification is performed by a corresponding signature method. In step S404, it is determined whether or not verification is successful, and the processing ends if the verification fails. In a case where verification is successful, in step S405, the reset function 121c is used to reset the bank 0 and thereby set the bank 0 to an executable state. Then, in step S406, the boot loader program 122 is started up again and, in a case where signature verification is passed, the program control function 122c is used to start execution of the program 2.

As described above, it is possible to employ a plurality of cryptographic algorithms even when updating a program, whereby, in a case where the signature method A, for example, has been compromised and the necessity of a program update has arisen, it is possible to employ a different signature method that has not been compromised and ensure safety in terms of security.

### <First Embodiment for Time of Double-Bank Configuration>

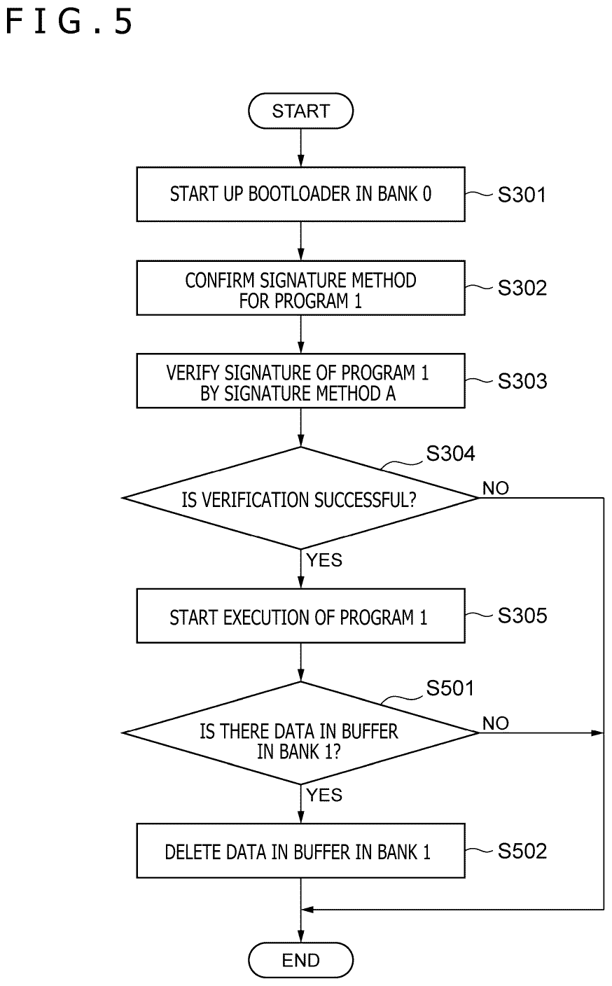

Next, with use of FIG. 5 through FIG. 11, description is given regarding processing in a case where the ROM 12 having the double-bank configuration illustrated in FIG. 2(b) is employed. FIG. 5 is a flow chart that illustrates a secure boot process that is executed when the information processing apparatus 1 having the ROM 12 with the double-bank configuration is caused to start up.

Regarding processing at this time, from step S301 to step S305 is the same as processing for the time of the single-bank configuration, and description thereof is omitted. In a case where the double-bank configuration is employed, steps S501 and S502 are added.

After execution of the program 1 is started in step S305, in step S501, using the program control function 122c in the bank 0, it is determined whether or not there is program data in a buffer (region to which a program is deployed) in the bank 1. Then, in a case where there is program data, in step S502, the program data is deleted. Note that this deletion process does not need to be executed.

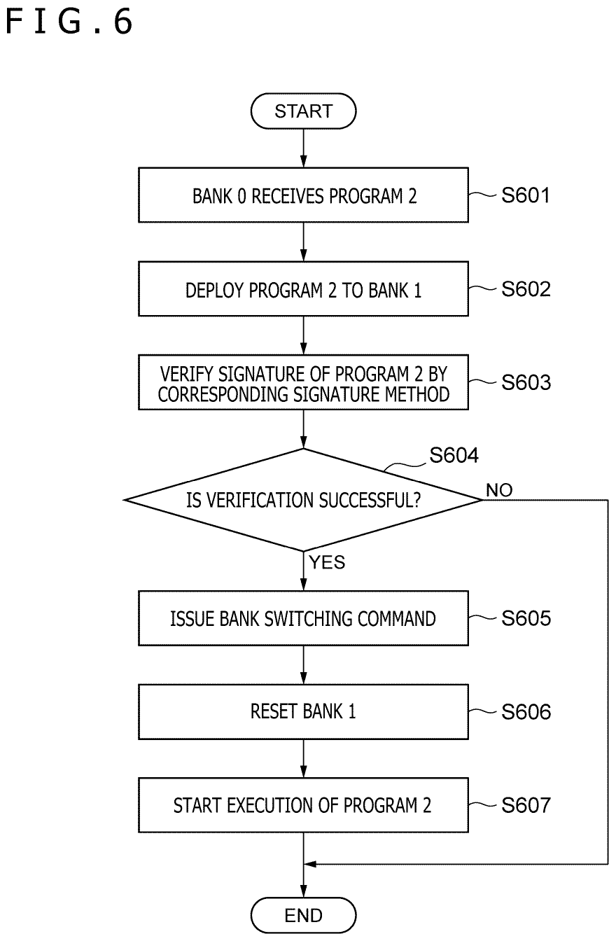

Next, with use of FIG. 6, description is given regarding an update process performed in a case where a necessity of updating the program 1 has arisen. Note that, in the present embodiment, the boot loader program 122 cannot be rewritten, and the control program 121 can be rewritten only when the boot loader program 122 or the control program 121 from another bank is executed.

Firstly, in step S601, the program reception function 121a in the bank 0 is used to receive an update program 2 from the update program management server 3. In step S602, the program deployment function 121b is used to deploy the program 2 to the buffer in the bank 1. Note that, in addition the signature method A, it is possible to employ another signature method that is stored by the cryptographic algorithm storage function 122d, as the signature method for the program 2, in the present embodiment as well.

In step S603, the boot loader program 122 is started up again, and signature verification is performed by a corresponding signature method. In step S604, it is determined whether or not verification is successful, and the processing ends if the verification fails. In a case where verification is successful, in steps S605 and S606, the bank switching/reset function 121d is used to issue a switching command for switching an operation region from the bank 0 to the bank 1, and also reset the bank 1 to thereby set the bank 1 to an executable state. In step S607, the program control function 122c is used to start execution of the program 2.

Also in the present embodiment, as with the time of the single-bank configuration, it is possible to employ a plurality of cryptographic algorithms even when updating a program, whereby, in a case where the signature method A, for example, has been compromised and the necessity of a program update has arisen, it is possible to employ a different signature method that has not been compromised and ensure safety in terms of security.

Further, by employing the double-bank configuration, it becomes possible to have a robust OTA mechanism that is employed when an update program is received and, by keeping data in the bank 0 unchanged, it becomes possible to perform a rollback process for returning the operation region from the bank 1 to the bank 0. Moreover, the update program 2 is set to be the same as the program 1, whereby it becomes possible to also ensure redundancy.

### <Second Embodiment for Time of Double-Bank Configuration>

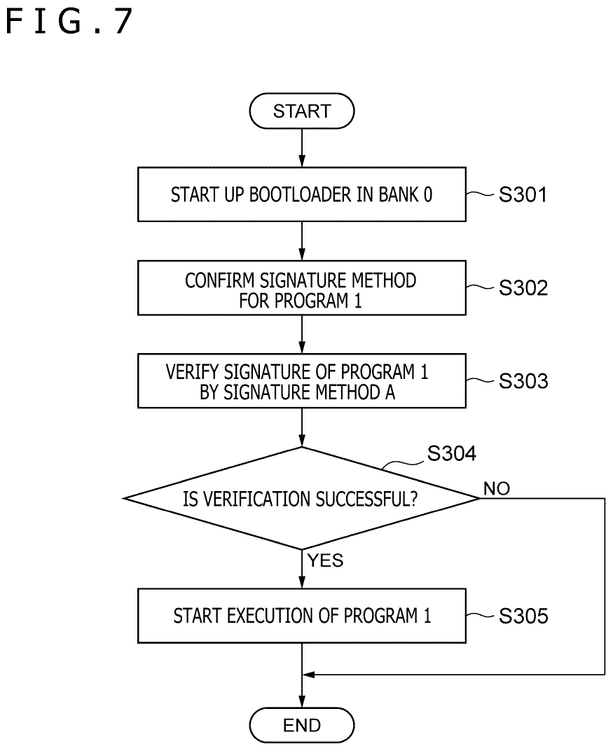

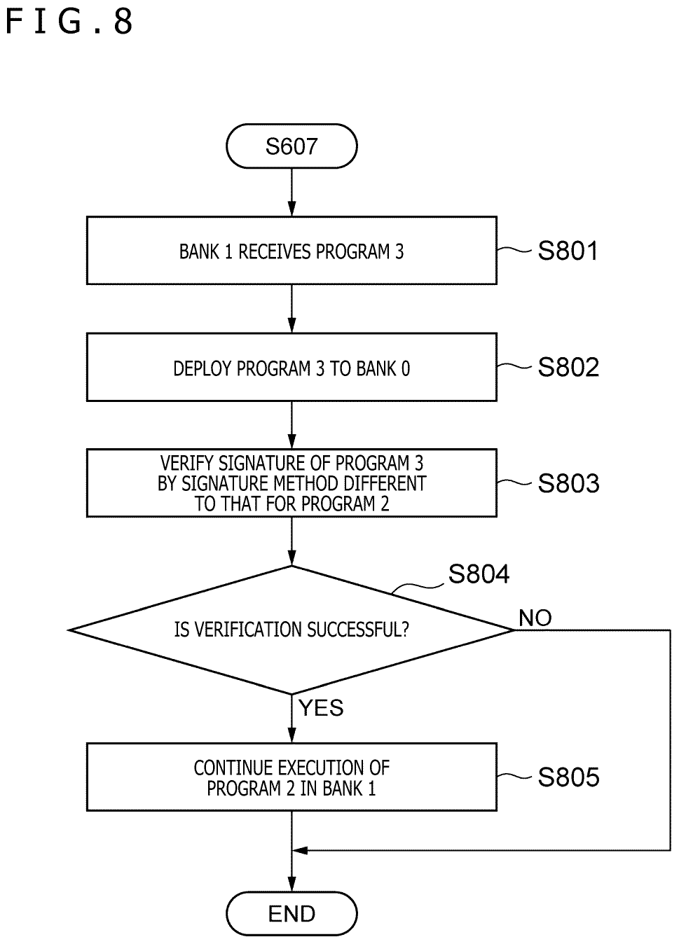

Next, FIG. 7 and FIG. 8 are used to give a description regarding processing executed by the information processing apparatus 1 that has the ROM 12 with the double-bank configuration according to a second embodiment. Note that program data is described in the first embodiment as not needing to be present in the bank 1 when processing is started but, in the following embodiment, there is a premise that, when processing is started, a program 1 having the signature method A is stored in the bank 0 and a program that has a signature method B which differs to the signature method A and that has the same contents as those of the program 1 is stored in the bank 1.

FIG. 7 is a flow chart that illustrates a secure boot process that is executed when the information processing apparatus 1 having the ROM 12 with the double-bank configuration according to the second embodiment is caused to start up. As illustrated in FIG. 7, in the present embodiment, steps S501 and S502 have been deleted from the secure boot process that is according to the first embodiment and is illustrated in FIG. 5. In other words, a process that is the same as the secure boot process performed by the information processing apparatus 1 having a ROM with the single-bank configuration is executed in the present embodiment. The program that is stored in the bank 1 as described above has the same contents as those of the program 1 and has the signature method B that is different. As a result, in a case where, for example, the signature method A for the program 1 is compromised and the signature method B has not been compromised, it becomes possible to quickly switch an operation region from the bank 0 to the bank 1 and ensure safety in terms of security.

Next, FIG. 8 is used to give an explanation regarding a process for updating the program 1 that is stored in the bank 0.

In the present embodiment, firstly, steps S601 to S607, which are illustrated in FIG. 6, are the same as processing executed in the first embodiment.

In the present embodiment, steps S801 through S805 are added to the processing in the first embodiment. After processing pertaining to the program 2 in the bank 1 in FIG. 6 is started, in step S801, an update program 3 is newly received using the program reception function 121a in the control program 121 in the bank 1. This program 3 has the same contents as those of the program 2 stored in the bank 1 and has a different signature method.

In step S802, the program deployment function 121b is used to deploy the program 3 to the bank 0. In step S803, the signature verification function 122b is used to verify the signature of the program 3. As described above, this signature has a signature method that differs to that for the signature method B for the program 2.

In step S804, it is determined whether or not signature verification is successful, and the processing ends if the signature verification fails. In a case where signature verification is successful, a transition to step S805 is made. Here, in a case where signature verification for an updated program is successful, the bank for the operation region is switched in the first embodiment, but, in the present embodiment, execution of the program 2 in the bank 1 continues without switching banks, as illustrated in step S805. As described above, the program 3 has the same contents as those of the program 2 and has a different signature method. Therefore, in a case where the signature method for the program 2 is compromised and the signature method for the program 3 has not been compromised, for example, by switching the operation region from the bank 1 to the bank 0, it becomes possible to ensure safety in terms of security while performing the same processing as that by the program 2.

### <Third Embodiment for Double Bank>

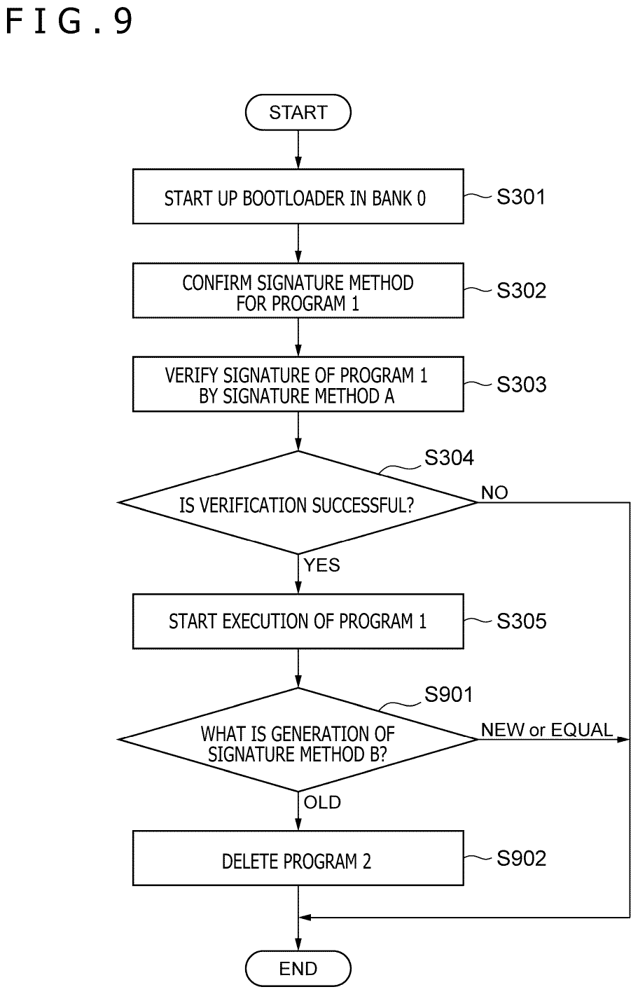

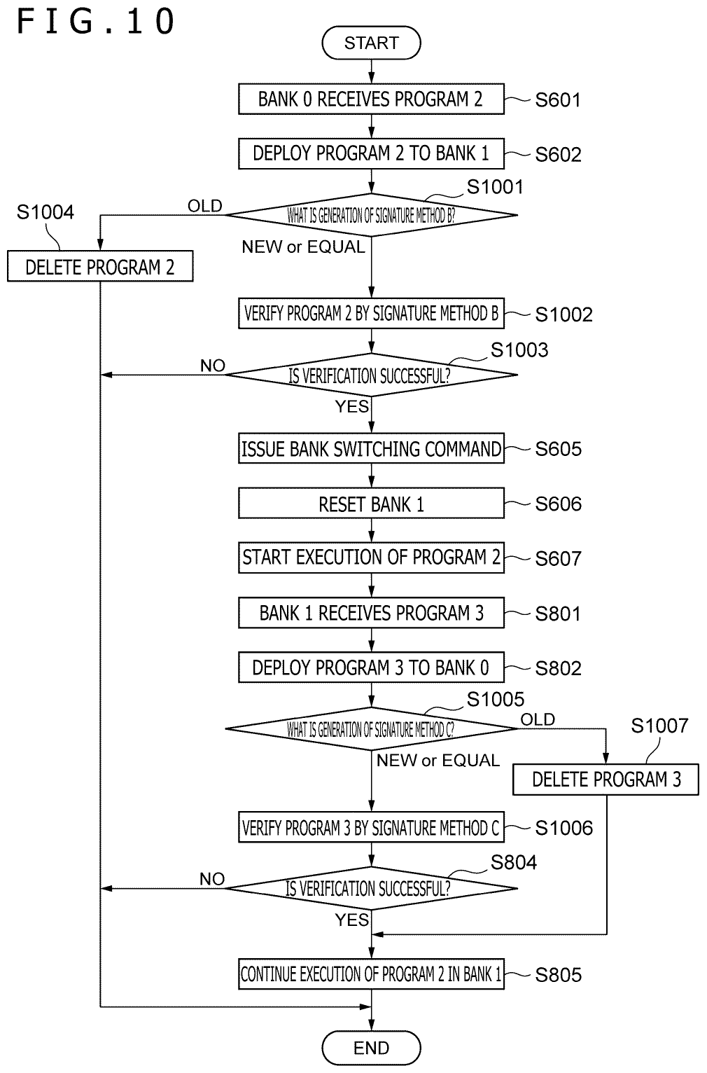

Next, FIG. 9 and FIG. 10 are used to give a description regarding processing executed by the information processing apparatus 1 that has the ROM 12 with the double-bank configuration according to a third embodiment.

FIG. 9 is a flow chart that illustrates a secure boot process that is executed when the information processing apparatus 1 having the ROM 12 with the double-bank configuration according to the third embodiment is caused to start up. As illustrated in FIG. 9, in the present embodiment, steps S901 and S902 have been added to the secure boot process that is according to the second embodiment and is illustrated in FIG. 7.

In the present embodiment, after execution of the program 1 is started in step S305, the signature method confirmation function 122a of the boot loader program 122 is used to also verify the generation of the signature method A for the program 1 in the bank 0 as well as the generation of the signature method B for a program stored in the bank 1.

Here, description is given regarding the generation of a signature method. As described above, RSA or elliptic curve cryptography, for example, are often used as a cipher that is used in a secure boot. However, it is ascertained that these ciphers will easily be deciphered when a quantum computer is realized. Accordingly, there has been progress in implementing quantum-resistant cryptography that cannot easily be deciphered even if a quantum computer is used (for example, lattice cryptography). In this case, it can be said that the generation of lattice cryptography is newer than a generation of RSA or elliptic curve cryptography. In this manner, in a case where a technique that enables a cipher belonging to a certain generation A to be deciphered is implemented, when a cipher that cannot easily be deciphered even if this technique is used is implemented in the next generation B, the generation B is defined as newer than the generation A. In other words, a signature method belonging to an older generation is more likely to be compromised than a signature method belonging to a newer generation, or is already compromised.

Accordingly, in step S901, the generation of the signature method B for the program 2 in the bank 1 is confirmed. If this generation is older than the generation of the signature method A, there is a high possibility of already being compromised, and a vulnerability in terms of security has arisen. Accordingly, in a case where the generation of the signature method B is older than the generation of the signature method A, a transition to step S902 is made, and the program 2 is deleted.

Next, FIG. 10 is used to give a description regarding a program update process in the present embodiment. For a program update process in the present embodiment, steps S1001 through S1007, which correspond to processing added taking the generation of a signature method into consideration, are added. Description is given below regarding processing resulting from adding these.

After the program is deployed to the bank 1 in step S602, in step S1001, the signature method confirmation function 122a of the bank 0 is used to confirm the generation of the signature method B. In a case where the generation of the signature method B is older than the signature method A of the program 1, in step S1004, the program 2 is deleted for a reason similar to that described above, and the process ends.

In a case where the generation of the signature method B is the same as or newer than the generation of the signature method A, in steps S1002 and S1003, the signature verification function 122b is used to execute signature verification for the program 2. The subsequent steps S605 through S802 are similar to those in the second embodiment.

After the program 3 is deployed to the bank 0 again in step S802, in step S1005, the generation of a signature method C of the program 3 is compared with the generation of the signature method B of the program 2. Then, in a case where the generation of the signature method C is older than the generation of the signature method B, the program 3 is deleted in step S1007, and execution of the program 2 is continued in step S805. In a case where the generation of the signature method C is the same as or newer than the generation of the signature method B, in step S1006, the signature verification function 122b of the boot loader program 122 in the bank 0 is used to verify the signature of the program 3 by the signature method C.

In a case where signature verification fails in step S804, the processing ends. In a case where signature verification is successful, a transition to step S805 is made, and execution of the program 2 in the bank 1 continues.

By virtue of the present embodiment as above, a program update is performed in consideration of the generation of a signature method as well. As a result, it becomes possible to remove the risk of executing a program having a signature method that is already compromised.

### <Fourth Embodiment for Double Bank>

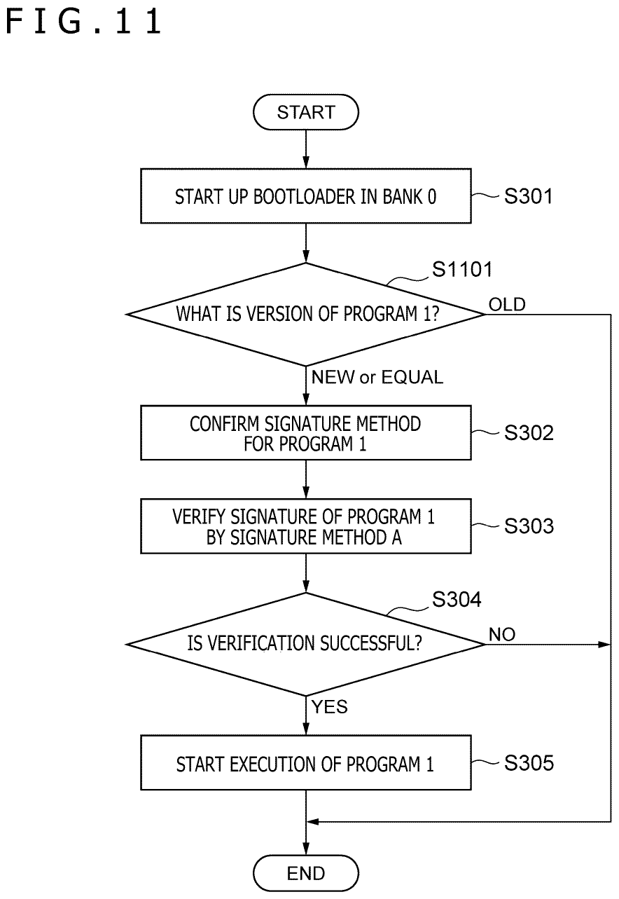

Finally, FIG. 11 is used to give a description regarding processing executed by the information processing apparatus 1 that has the ROM 12 with the double-bank configuration according to a fourth embodiment. In the present embodiment, processing for updating a program is similar to that in the second or third embodiment, but a secure boot process for when the information processing apparatus 1 starts up differs.

FIG. 11 is a flow chart that illustrates a secure boot process that is executed when the information processing apparatus 1 having the ROM 12 with the double-bank configuration according to the third embodiment is caused to start up. As illustrated in FIG. 11, in the present embodiment, step S1101 has been added to the secure boot process that is according to the second embodiment and is illustrated in FIG. 7.

In the present embodiment, after the boot loader in the bank 0 is started up, the program control function 122c is used to compare the version of the program 1 that is stored in the bank 0 with the version of a program that is stored in the bank 1. Then, in a case where the version of the program 1 stored in the bank 0 is older than the version of the program stored in the bank 1, subsequent processing is not performed. A transition to step S302 is made and signature verification for the program 1 stored in the bank 0 is performed only in a case where the version of the program 1 stored in the bank 0 is a version that is the same as or newer than the version of the program stored in the bank 1. Subsequent processing is similar to that in the embodiments described above.

By virtue of the present embodiment, it is possible to prevent execution of a control program that has an old version and has a problem of a vulnerability, for example.

By virtue of the embodiments of the present invention described above, the following operation and effects are achieved.

(1) An information processing apparatus according to one embodiment of the present invention has a computation unit that performs a computation process for a program and a storage unit that stores a first control program and a first startup program that executes signature verification for the first control program, the first startup program being able to execute a plurality of signature verification methods, and executing a process for determining, among the plurality of signature verification methods, a signature verification method that corresponds to a signature type for the first control program and obtaining a result of executing signature verification by the signature verification method.

By virtue of the above-described configuration, a transition to a different cryptographic algorithm is easily made in a case where a cryptographic algorithm for a secure boot is compromised, whereby it becomes possible to ensure safety in terms of security.

(2) The storage unit has a first storage region for storing the first control program and the first startup program, and a second storage region for storing a second control program that has a signature type different to that of the first control program and a second startup program that can execute a plurality of signature verification methods and executes signature verification by a signature verification method that is among the plurality of signature verification methods and corresponds to the signature type of the second control program. As a result, it becomes possible to have a robust OTA mechanism that is employed when an update program is received and, by keeping data in the bank 0 unchanged, it becomes possible to perform a rollback process for returning the operation region from the bank 1 to the bank 0. Further, the update program 2 is set to be the same as the program 1, whereby it becomes possible to also ensure redundancy.

(3) The signature verification is executed by the first startup program. As a result, it is possible to simply execute signature verification without adding a device such as an HSM for performing signature verification.

(4) After the second control program is stored in the second storage region, a storage region to be executed from is switched from the first storage region to the second storage region, and the first storage region stores a third control program that is the same control program as the second control program and has a signature of a type different to that of the signature of the second control program. As a result, it becomes possible to ensure redundancy for the second control program and the third control program.

(5) A comparison is performed between priority levels of a signature of the first control program and a signature of the second control program, and the control program having the signature that has a lower priority level is deleted. As a result, the generation or version of control programs are mutually compared, and it is possible to prevent the risk of a security vulnerability arising due to executing a program that is vulnerable or has a compromised signature method of an old generation or version.

(6) In a case where the second control program is received, a first priority level of a signature of the first control program is compared with a second priority level of a signature of the second control program, and the second control program is stored in the second storage region only when the first priority level is lower than the second priority level or when the first priority level is the same as the second priority level. As a result, as with (5), it is possible to prevent a risk of a security vulnerability arising due to executing a program that has a compromised signature method.

(7) In a case where the second control program is received, first software version information of the first control program is compared with second software version information of the second control program, and the second control program is stored in the second storage region only when the first software version information is older than the second software version information. As a result, as with (5), it is possible to prevent a risk of a security vulnerability arising due to executing a vulnerable program.

(8) The first startup program and the second startup program cannot be rewritten, the first control program can be rewritten only when the second startup program or the second control program is executed, and the second control program can be rewritten only when the first startup program or the first control program is executed. As a result, it is impossible to access a bank that is not the operation region apart from at a time of rewriting, and thus, it is possible to eliminate the risk of incorrect writing of data.

(9) In a case where the third control program is received, a second priority level of the signature verification method of the second control program is compared with a third priority level of a signature verification method of the third control program, and the third control program is stored in the first storage region only when the second priority level is lower than the third priority level or when the second priority level is the same as the third priority level. As a result, an effect similar to that for (5) is achieved.

(10) In the deletion of the control program, the first startup program deletes the second control program, and the second startup program deletes the first control program. As a result, it becomes possible to reduce memory capacity.

Note that the present invention is not limited to the embodiments described above, and various modifications are possible. For example, the embodiments described above are described in detail in order to describe the present invention in a way that is easy to understand. The present invention is not necessarily limited to an aspect that is provided with all of the described configurations. In addition, it is possible to replace a portion of a configuration of a certain embodiment with the configuration of another embodiment. In addition, it is also possible to add the configuration of another embodiment to the configuration of a certain embodiment. In addition, it is possible to perform an addition, deletion, or replacement of another configuration for a portion of the configuration of each embodiment.

### DESCRIPTION OF REFERENCE CHARACTERS

1: Information processing apparatus
11: CPU (computation unit)
12: ROM (storage unit)
121: Control program
122: Boot loader program (startup program)

1. An information processing apparatus comprising:
a computation unit that performs a computation process for a program; and
a storage unit that stores a first control program and a first startup program that executes signature verification for the first control program,
wherein the first startup program can execute a plurality of signature verification methods, and executes a process for determining, among the plurality of signature verification methods, a signature verification method that corresponds to a signature type for the first control program and obtaining a result of executing signature verification by the signature verification method.

2. The information processing apparatus according to claim 1, wherein
the storage unit has
a first storage region for storing the first control program and the first startup program, and
a second storage region for storing a second control program that has a signature type different to that of the first control program and a second startup program that can execute a plurality of signature verification methods and executes signature verification by a signature verification method that is among the plurality of signature verification methods and corresponds to the signature type of the second control program.

3. The information processing apparatus according to claim 1, wherein
the signature verification is executed by the first startup program.

4. The information processing apparatus according to claim 2, wherein,
after the second control program is stored in the second storage region, a storage region to be executed from is switched from the first storage region to the second storage region, and
the first storage region stores a third control program that is a same control program as the second control program and has a signature of a type different to that of the signature of the second control program.

5. The information processing apparatus according to claim 2, wherein
a comparison is performed between priority levels of a signature of the first control program and a signature of the second control program, and the control program having the signature that has a lower priority level is deleted.

6. The information processing apparatus according to claim 2, wherein,
in a case where the second control program is received, a first priority level of a signature of the first control program is compared with a second priority level of a signature of the second control program, and the second control program is stored in the second storage region only when the first priority level is lower than the second priority level or when the first priority level is same as the second priority level.

7. The information processing apparatus according to claim 2, wherein,
in a case where the second control program is received, first software version information of the first control program is compared with second software version information of the second control program, and the second control program is stored in the second storage region only when the first software version information is older than the second software version information.

8. The information processing apparatus according to claim 2, wherein
the first startup program and the second startup program cannot be rewritten,
the first control program can be rewritten only when the second startup program or the second control program is executed, and
the second control program can be rewritten only when the first startup program or the first control program is executed.

9. The information processing apparatus according to claim 5, wherein,
in a case where a third control program is received, a second priority level of the signature verification method of the second control program is compared with a third priority level of a signature verification method of the third control program, and the third control program is stored in the first storage region only when the second priority level is lower than the third priority level or when the second priority level is same as the third priority level.

10. The information processing apparatus according to claim 5, wherein,
in the deletion of the control program,
the first startup program deletes the second control program, and
the second startup program deletes the first control program.
